(19) United States
(12) Patent Application Publication
(10) Pub. No.: US 2026/0119596 A1
(43) Pub. Date: Apr. 30, 2026

(54) COMPUTING RESOURCE OPTIMIZATION ENGINE BASED ON SOCIAL CONTENT

(71) Applicant: AMADEUS S.A.S., Biot (FR)

(72) Inventors: Jeremy JAMESON, Irving, TX (US); Jonathan SCHERBEL, Herriman, UT (US); Darin STROMBERG, Kaysville, UT (US); Benjamin NOFFSINGER, West Valley City, UT (US); Angelo Ian CRUZ, Pasay (PH); Thaddeus BECK, Salt Lake City, UT (US)

(21) Appl. No.: 19/432,504

(22) Filed: Dec. 24, 2025

Related U.S. Application Data
(62) Division of application No. 18/102,308, filed on Jan. 27, 2023.

(51) Int. Cl. G06F 16/957; G06F 16/587; G06Q 10/02

(52) U.S. Cl. CPC G06F 16/9577; G06F 16/587; G06Q 10/025

(57) ABSTRACT

The present specification provides, amongst other things, a novel computing resource optimization engine. In one example system, a plurality of publisher platforms for access by a plurality of client devices is provided. The plurality of publisher platforms can carry certain content for direct consumption and additional content for suggesting diversion to one of a plurality of target platforms. Each publisher platform may generate unique primary content but be configured to carry similar secondary content for the suggested diversion. The system includes an optimization engine configured to reduce wasted network bandwidth and other computing resources by embedding the diversionary content into the primary content, thereby biasing the diversionary content on the publisher platforms towards the client devices that more commonly result in generation of secondary content that actually causes diversions to the target platforms.

### RELATED APPLICATION

This application is a divisional application of U.S. application Ser. No. 18/102,308, filed Jan. 27, 2023, which is incorporated herein by reference in its entirety.

### BACKGROUND

Communication activity on the modern Internet is distributed amongst many different server platforms offering content to millions of different client devices. Certain platforms offer similar types of content and thus compete for connections from the same client devices. Furthermore, many platforms may carry additional content intended to cause input from client devices that will divert traffic to another platform. However, the additional content may not trigger such input resulting in an overall wastage of computing resources by generating and transmitting additional content which is ignored.

### BRIEF DESCRIPTION OF THE FIGURES

FIG. 1 is a schematic diagram of a system for computing resource optimization.

FIG. 2 shows an example structure of the identifier objects of FIG. 1.

FIG. 3 is a block diagram of example internal components of the optimization engine of FIG. 1.

FIG. 4 shows a flowchart depicting a method for computing resource optimization.

FIG. 5 shows an example performance of certain blocks in the method of FIG. 4.

FIG. 6 shows an example performance of certain blocks in the method of FIG. 4.

FIG. 7 shows an example of a client device from FIG. 1 being controlled by according to an embodiment.

### DETAILED DESCRIPTION

An aspect of the present specification provides a novel computing resource optimization engine. In one example system, a plurality of publisher platforms for access by a plurality of client devices is provided. The plurality of publisher platforms can carry certain content for direct consumption and additional content for suggesting diversion to one of a plurality of target platforms. Each publisher platform may generate unique primary content but be configured to carry similar secondary content for the suggested diversion. The primary content and the secondary content may be hybridized in real-time. The system includes an optimization engine configured to reduce wasted network bandwidth and other computing resources by biasing the additional content on the publisher platforms towards the client devices that more commonly result in generation of secondary content that actually causes diversions to the target platforms.

An aspect of this specification provides a server for controlling content for generation on a client device. The server can comprise a processor and a memory for storing a plurality of programming instructions for execution on the processor and that when executed configure the processor to receive a platform account profile associated with a content platform. The account profile includes an origin. The processor is further configured to receive a data feed for the account profile from the content platform. The data feed includes a destination. The processor is further configured to receive a held travel itinerary from a travel-actor data source engine configured to determine the travel itinerary based on at least one of the origin or the destination, and to control a client device associated with account profile that embeds the travel itinerary into the data feed.

The travel itinerary can include a transportation routing from the origin to the destination, including a departure date and time, an arrival date and time and a transportation mode.

The travel itinerary can include a lodging at the destination.

The data feed can include a plurality of segmented primary content items directed to the account profile.

The destination can be derived from an image of the destination, and the travel itinerary can be embedded into the image.

The travel itinerary can include a link that when selected on the client device sends a signal to the travel-actor data source engine that assigns the account profile to the travel itinerary and changes the held (or purchasable) travel itinerary to a purchased travel itinerary.

The account profile can be associated with an electronic wallet and wherein the signal causes a change to the electronic wallet corresponding to a value of the travel itinerary.

The processor can be further configured to assign a copy of the purchased travel itinerary to the account profile.

The account profile can be associated with a travel profile and the travel-actor data source engine is configured to determine the travel itinerary additionally based on the travel profile.

The engine can be further configured to determine the itinerary based on one or more of a date range; a price; a promotional code; a lowest price; a shortest travel time; popular days of week and times of day for travel; prevalent lengths-of-stay for travel from the origin to the destination; and, a preferred carrier.

Another aspect of this specification provides a computer-implemented method for displaying services on a user device displaying a browser page, comprising:
determining service data related to an image of the browser page;
retrieving, based on the service data related to the image, a list of services from a database;
displaying a graphical user interface element in the browser page;
upon receiving user input related to the graphical user interface element, displaying a result corresponding to the retrieved list of services on the user device,
wherein the steps of determining and retrieving are executed as a continuous task on the user device.

The determining service data related to the image can comprise identifying a geographical location displayed in the image.

The geographical location can be based on geolocation metadata associated with the image.

The determining service data can be related to the image comprises identifying an activity related to the image.

The origin can be determined based on user-related location data, and the retrieving can also be based on the origin.

The user-related location data can comprise the Internet Protocol (IP) address of the user device or global positioning system (“GPS”) data of the device.

The graphical user interface element can be configured so that it is only displayed if service data related to the image has been determined and a list of services has been retrieved from the database.

The retrieving can be based on an account profile.

The method can comprise identifying an image on the browser page.

The identifying can be according to on an image that is based on any of the following:
on a filtering based on the account profile;
the absence of a contents scroll related to the browser page;
cursor-based or touch-based interaction of the user related to the image.

The method can further comprise, upon receiving user input related to the graphical user element, launching a supplementary search based on the retrieved list of services.

The user input can be related to the graphical user element which comprises receiving user input data for the retrieved list of services and the supplementary search can be based on the user input data.

The method can further provide an option to view the result from the supplementary search and to book the service corresponding to the result.

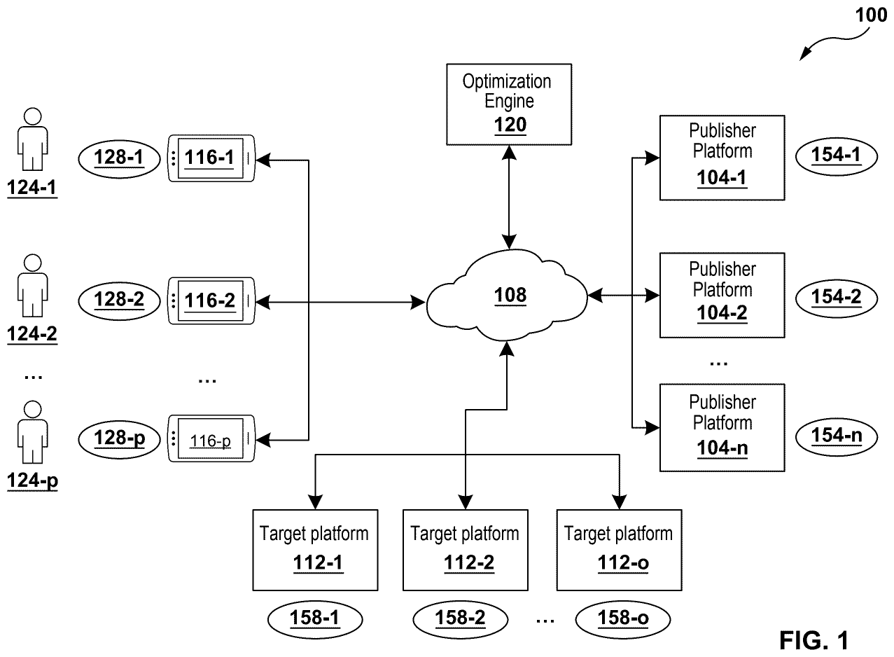

FIG. 1 shows a system for network traffic monitoring and optimization indicated generally at 100. System 100 comprises a plurality of publisher platforms 104-1, 104-2 . . . 104-n. (Collectively, platforms 104-1, 104-2 . . . 104-n are referred to as platforms 104, and generically, as platform 104. This nomenclature is used elsewhere herein.) In system 100, platforms 104 connect to a network 108 such as the Internet. Network 108 interconnects publisher platforms 104 with: a) a plurality of target platforms 112; b) a plurality of client devices 116; and, d) an optimization engine 120. As will be discussed further below, optimization engine 120 performs a number of processing functions on system 100.

Platforms 104 can be based on any present or future electronic media servers that publish content for client devices 116. Client devices 116 can be any type of human-machine interface for interacting with platforms 104. For example, client devices 116 can include traditional laptop computers, desktop computers, mobile phones, tablet computers and any other device that can be used to receive content via one or more of the platforms 104 that complements the input and output hardware devices associated with a given client device 116. It is contemplated client devices 116 can include virtual or augmented reality gear complementary to virtual reality or augmented reality or “metaverse” environments that can be offered on publisher platforms 104. Client devices 116 can be operated by different users 124 that are associated with a respective identifier object 128 that uniquely identifies a given user 124 accessing a given client device 116 in system 100.

In a present example embodiment, platforms 104 can be based on media platforms that carry primary content for direct consumption by users 124 at client devices 116, while also generating secondary content in the form of advertising from services. (Herein, secondary content may sometimes be referred to as diversion content or diversionary content).

To elaborate, publisher platforms 104 can be based on social media ecosystems such as, TikTok, Instagram, Facebook or the like which generate primary content, (e.g. social media posts of users 124) and can embed their own secondary content (e.g. advertising of products or services available from target platforms 112) intended to divert a given client device 116 from the publisher platform 104 towards a specific target platform 112 that is associated with the secondary content. Publisher platforms 104 can also be based on ecosystems such as Google, that include primary content delivered via YouTube, Google Maps, Google Search, Google News, while also embedding secondary content intended to direct traffic to target platforms 112. Primary content can also be provided by publisher platforms 104 that offer web pages, social media, audio, video, movies, television, games, books, news, search results, and the like. The nature of publisher platforms 104 is thus not particularly limited. Very generally, platforms 104 carry primary content for consumption by client devices 116 and secondary content for diverting traffic to target platforms 112.

In general, secondary content is typically generated in association with the primary content and, in a present embodiment, is typically advertising. Advertising can be generated and managed by advertising services such as Google (Google AdEx/Google DV360 . . . ), or Facebook (Social campaigns), or Amadeus Media Services programmatic/display/video . . . ), that can embed or otherwise associate advertising content into primary content provided by other websites or apps or other primary content from platforms 104. To reiterate, secondary content is any content that, when accessed or selected on a platform 104 by a given client device 116, can cause an interaction with a target platform 112.

According to a specific illustrative example, the present specification can have particular application to the travel industry and thus may (but need not) bias towards primary content of interest to users 124 who are known to be travelers, while secondary content may be more likely to include travel advertisements including pre-curated travel itineraries that are intended to direct traffic to target platforms 112 that are travel actors and sell travel services.

Travel actors can broadly encompass different categories of all types of travel service offerings including transportation-actors; accommodation-actors and travel-destination actors. Transportation-actors can provide transportation services for users 124, such as airlines, rental car agencies, rail services, ferries, and bus lines. Accommodation-actors can provide lodging for users 124, such as hotels, vacation rentals, resorts and B&Bs (“Bed and Breakfasts”), including the lodging at the location where a user 124 arrives after receiving a transportation service. Travel-destination actors can include providers of activities at the location where a user 124 is lodging. Travel-destination actors can thus include, by way of non-limiting examples, restaurants, spas, concert venues, exhibition centers, summits, sporting event venues, fairs, conference venues, sporting arenas, museums, art galleries, tours and resort activity centers and the like.

According to the specific illustrative example discussed further below, target platforms 112 may focus on platforms 112 that generate content of interest to travelers. In certain presently preferred embodiments, platforms 112 reference transportation-actors and their sales workflows. However, platforms 112 may also include travel-destination target platforms 112. Furthermore, platforms 112 can also include a travel actor which has connectivity to partners, thereby enabling the sale of a variety and/or bundle of services, for example a transportation-actor which is able to sell its own flights together with services from accommodation-actors and travel-destination actors. Regardless, platforms 112 may include an e-commerce environment including a sales workflow or interactive sales function for client devices 116, representing a customer experience sales funnel, including experiences such as travel itinerary prediction and fulfillment as well as service searching, service browsing, adding a service to shopping cart, checkout, fare lock and temporary inventory holds to be provided for a fee, and payment processing.

As will be discussed in greater detail below, according to the certain embodiments, optimization engine 120 is configured to provide secondary content that is interactive by suggesting a complete service, such as a travel itinerary, fully costed with payment processing, such that selection of the secondary content while generated on the publisher platform 104 results in a complete fulfillment of an electronic transaction that exchanges electronic payment messages representing financial fulfillment from a financial account associated with a user identifier object 128 with electronic itinerary fulfillment messages representing a complete travel itinerary (or other service) being associated with one or more user identifier objects 128 for use by associated user 124. This example may be referred to elsewhere as “travel itinerary fulfillment” or “complete travel itinerary fulfillment” or variants thereon according to context. When the embodiments herein are applied beyond travel itineraries, “travel itinerary fulfillment” may be seen more broadly as “service offering fulfillment”, where service offerings may include other complete offerings such as dynamic packages of flights plus hotel, admission tickets to concerts or other travel-destination activities.

Accordingly, client devices 116 are based on any suitable client computing platform operated by users 124 that may have an interest in the content being provided on platforms 104 and the services being offered on target platforms 112. Each device 116 and its user 124 is thus associated with a user identifier object 128. Client computing platforms can include desktop computers, laptop computers, tablet computers, mobile telephones and the like.

A person of skill in the art is to recognize that the form of an identifier object 128 is not particularly limited, and in a simple example embodiment, can be simply an alpha-numerical sequence that is entirely unique in relation to other identifier objects in system 100. Identifier objects can also be more complex as they may be combinations of account credentials (e.g. user name, password, Two-factor authentication token, etc.) that uniquely identify a given user 124. Identifier objects themselves may also be indexes that point to other identifier objects, such as accounts. The salient point is that they are uniquely identifiable within system 100 in association with what they represent.

Users 124 are typically individuals but may be corporate entities. Such users 124 interact, via devices 116, with both publisher platforms 104 as well as target platforms 112. Each consumer identifier object 128 can be used by other nodes in system 100, including publisher platforms 104, target platform 112 and optimization engine 120 to track, amongst other things: a) traffic flows between a given client device 116 and various publisher platforms 104, including interactions (impressions as well as diversions) with a given advertising campaign; b) traffic flows between a given client device 116 and target platform 112; c) diversions of traffic originated by a given client device 116 from a given publisher platform 104 to target platform 112; and d) travel-itinerary fulfillments arising from selection of secondary content generated on one of the publisher platforms 104.

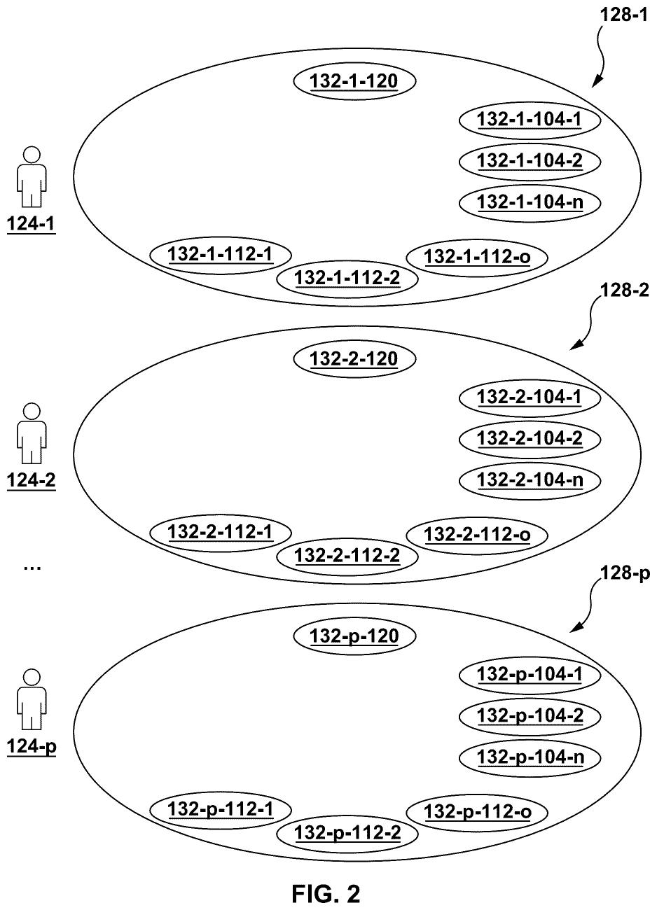

FIG. 2 shows a non-limiting example of how consumer identifier objects 128 can be implemented as a plurality of consumer identifier sub-objects 132. Consumer identifier sub-objects 132 follow the nomenclature 132-X-Y where X corresponds to reference for a corresponding user 124 and Y corresponds to the reference for a corresponding node in system 100. (This nomenclature builds on the earlier-discussed nomenclature, since consumer identifier objects are referred to collectively as consumer identifier objects 128 and generically as consumer identifier object 128.) To elaborate, sub-objects 132-1-Y refer to user 124-1; sub-objects 132-2-Y refer to user 124-2; sub-objects 132-p-Y refer to user 124-p. Sub-object identifier 132-1-120 refers to the identifier for user 124-1 for optimization engine 120. Sub-object identifier 132-1-104-1 refers to the identifier for user 124-1 for platform 104-1. Sub-object identifier 132-1-104-2 refers to the identifier for user 124-1 for platform 104-2. This nomenclature repeats for all identifier sub-objects 132 for each user 124, across each publisher platform 104 and each target platform 112.

Sub-objects 132 may be provided to anonymize, for privacy purposes, the specific identity (i.e. personally identifying information or PII) of the associated user 124. Some or all of those identifier sub-objects 132 may be anonymous or private to certain nodes in system 100 while being non-private to other nodes. For example, the operator of a target platform 112 may maintain an account (a form of consumer identifier sub-object 132-X-112) respective to each user 124-X that expressly identifies the user 124-X to handle delivery and payment processing of a given purchased good or service, such as a ticket or voucher for a service at a travel destination. At the same time, the operator of publisher platform 104 need not expressly identify a given user 124 in order to fulfill its advertising campaign functions, but can instead rely upon, (via “cookies”, type of identifier sub-object 132-X-104, or the like), generic demographic information respective to the user 124-X that can be configured to permit targeting of an advertising campaign to a client device 116 while respecting the individual anonymity of the user 124-X of the client device 116. Accordingly, in certain embodiments, it is contemplated that a consumer identifier sub-object 132 may comprise a cookie that is used by a publisher platform 104, whereas another consumer identifier sub-object 132 may comprise the account information of the user 124 as used by target platform 112. However, for simplification of explanation of the present embodiment, a single consumer identifier object 128 for each user 124 may be referenced in this specification, but a person skilled in the art will now appreciate such simplification and that contextually, a reference to an identifier object 128 for a given node in system 100 may involve the use of a consumer identifier sub-object 132 instead. By the same token, it is this contextual complexity that reveals one of the technical advantages of the present specification, which will become apparent with further reading, in that the disparate and often anonymous nature of identifier sub-objects 132 make load balancing of system 100 difficult, a difficulty that is mitigated by the present specification.

For simplicity in explanation, however, the following discussion may simply refer to consumer identifier object 128, but a person of skill in the art will recognize that consumer identifier object 128 may be implemented according to FIG. 2.

Referring again to FIG. 1, persons skilled in the art will recognize that there are many different types of interactions between client devices 116 accessing platforms 104, and that there are many different ways such interactions may lead to diversions that cause a given client device 116 to access target platform 112. In a presently preferred example embodiment, the diversions result in a fulfillment of a complete travel itinerary suggested inside the secondary content on platform 104. However, in other embodiments a complete fulfillment may not occur and it is possible that there will be partial fulfillments, with potentially repeated diversions from the same or different platforms 104 during different stages of a sales funnel experience of target platform 112 that can lead to a complete fulfillment. For example, in the case of partial fulfillments, client device 116-1 may access platform 104-1 and be exposed to an advertisement connected to an advertising campaign that causes client device 116-1 to direct traffic to an “offer for sale” web page on platform 112-1 that is offering a service, such as a complete travel itinerary. As part of the sales funnel experience, the client device 116-1 may send input that “adds” that service to a virtual “shopping cart” on target platform 112-1, but client device 116-1 may not, during the same session, send input that completes the “checkout” portion of the sales funnel experience. This incomplete sales funnel experience can then be logged within system 100 such that, during a subsequent access from client device 116-1 to platform 104-1, there may be exposure to another version of the secondary content in the form of an advertisement, that causes traffic from client device 116-1 to be directed to a “checkout” web page on target platform 112-1, urging completion of the “checkout” or purchasing portion of the sales funnel experience. To reiterate, this is but one example and with the benefit of further study of this specification a person of skill in the art will appreciate how the present teachings can be applied to these different types of interactions between client devices 116, publisher platforms 104 and the sales funnel experience on target platform 112.

It is contemplated that each publisher platform 104 has a publisher-reporting application 154 stored in non-volatile storage of the respective platform 104 and executable on its processor. The publisher-reporting application 154 can be accessed by optimization engine 120 to track the number of impressions and/or diversions (if any) from the respective publisher platform 104 to target platforms 112 that are associated with each consumer identifier object 128. The publisher-reporting application 154 can also be used to track queries or search for a given identifier 128 (or a given sub-object identifier 132-X-104) or the types of primary content being accessed on the platform 104. For example, repeated searches for a travel destination for an activity at a travel destination may be recorded in application 154 for later access by optimization engine 120 and/or publisher platform 104 to generate primary content and/or secondary content relevant to that destination.

It is contemplated that target platforms 112 also include a target-reporting application 158 stored in non-volatile storage and executable on their processors. The target-reporting application 158 can track the various stages of the sales funnel experience for a user 124 via their respective identifier object 128. Target-reporting applications 158 can also maintain historical and future travel itineraries for each identifier 128.

Optimization engine 120 can also be configured to obtain reports based on: a) the reports from each publisher-reporting application 154; in combination with b) reports from target-reporting application 158. Such reports thereby simplify the process of comparing the relative progress through the sales funnel experience, including actual sales conversions, associated with a given advertising campaign on each publisher platform 104 for a respective product. In turn, the normalized reports can be used to adjust advertising campaigns and/or control which platform servers 104 are provided with advertising campaigns, thereby reducing or eliminating wasted delivery (and associated waste of communication and other computing resources) of advertising campaigns from publisher platforms 104 that do not result in diversions to target platform 112.

Optimization engine 120 can also be configured to access publisher-reporting applications 154 to note, in the aggregate, top impressions of destinations by users 124 while preserving anonymity of those users 124.

Optimization engine 120 can also be configured to access target-reporting applications 158 to obtain demographic data for different users 124. If permission is granted by a user 124 then optimization engine 120 may specifically identify a given user 124; or if no permission is granted, then optimization engine 120 may only access meta-results such as generalized demographic data for the user 124.

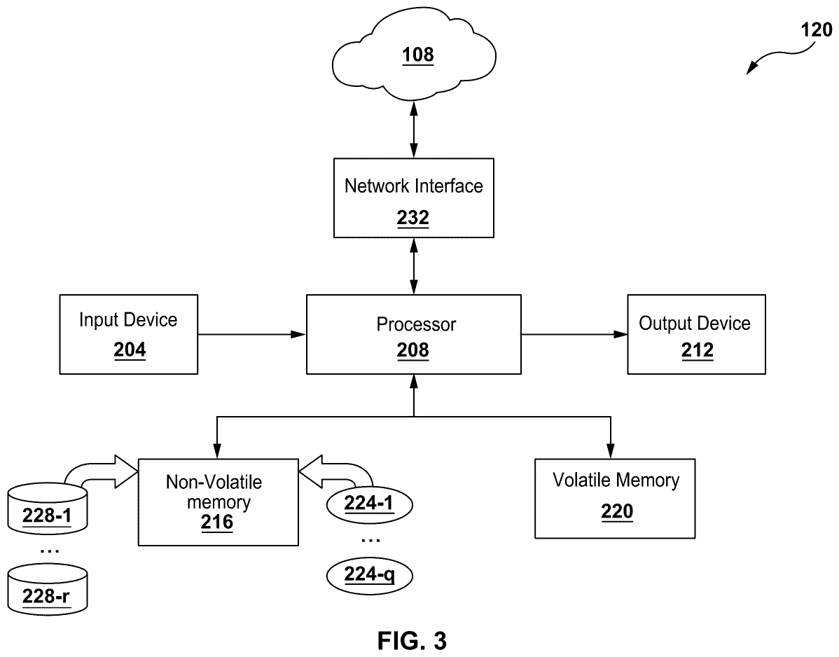

Having described an overview of system 100, it is useful to comment on the hardware infrastructure of system 100. FIG. 3 shows a schematic diagram of a non-limiting example of internal components of optimization engine 120.

In this example, optimization engine 120 includes at least one input device 204. Input from device 204 is received at a processor 208 which in turn controls an output device 212. Input device 204 can be a traditional keyboard and/or mouse to provide physical input. Likewise output device 212 can be a display. In variants, additional and/or other input devices 204 or output devices 212 are contemplated or may be omitted altogether as the context requires.

Processor 208 may be implemented as a plurality of processors or one or more multi-core processors. The processor 208 may be configured to execute different programing instructions responsive to the input received via the one or more input devices 204 and to control one or more output devices 212 to generate output on those devices.

To fulfill its programming functions, the processor 208 is configured to communicate with one or more memory units, including non-volatile memory 216 and volatile memory 220. Non-volatile memory 216 can be based on any persistent memory technology, such as an Erasable Electronic Programmable Read Only Memory (“EEPROM”), flash memory, solid-state hard disk (SSD), other type of hard-disk, or combinations of them. Non-volatile memory 216 may also be described as a non-transitory computer readable media. Also, more than one type of non-volatile memory 216 may be provided.

Volatile memory 220 is based on any random access memory (RAM) technology. For example, volatile memory 220 can be based on a Double Data Rate (DDR) Synchronous Dynamic Random-Access Memory (SDRAM). Other types of volatile memory 220 are contemplated.

Processor 208 also connects to network 108 via a network interface 232. Network interface 232 can also be used to connect another computing device that has an input and output device, thereby obviating the need for input device 204 and/or output device 212 altogether.

Programming instructions in the form of applications 224 are typically maintained, persistently, in non-volatile memory 216 and used by the processor 208 which reads from and writes to volatile memory 220 during the execution of applications 224. Various methods discussed herein can be coded as one or more applications 224. One or more tables or databases 228 are maintained in non-volatile memory 216 for use by applications 224.

The infrastructure of optimization engine 120, or a variant thereon, can be used to implement any of the computing nodes in system 100, including platforms 104 and target platform 112. Furthermore, optimization engine 120, platforms 104 and target platform 112 may also be implemented as virtual machines and/or with mirror images to provide load balancing. Functions of optimization engine 120 may also be distributed amongst different target platforms 112 and/or platforms 114, thereby obviating the need for a central optimization engine 120. By the same token, a plurality of optimization engines 120 may be provided.

Furthermore, a person of skill in the art will recognize that the core elements of processor 208, input device 204, output device 212, non-volatile memory 216, volatile memory 220 and network interface 232, as described in relation to the server environment of optimization engine 120, have analogues in the different form factors of client machines such as those that can be used to implement client devices 116. Again, client devices 116 can be based on computer workstations, laptop computers, tablet computers, mobile telephony devices or the like.

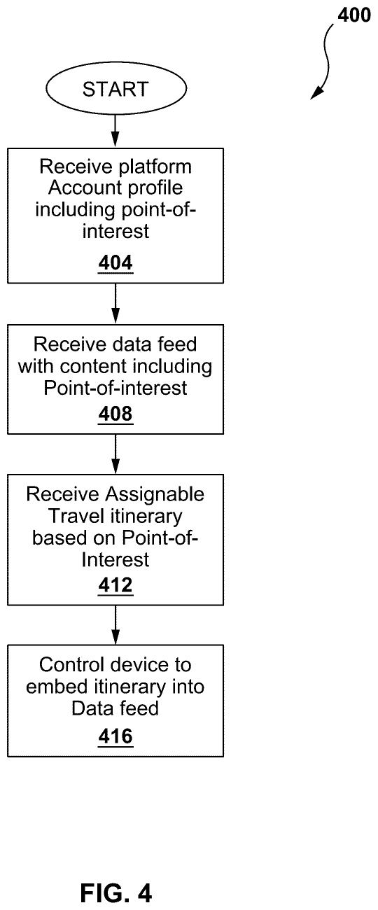

FIG. 4 shows a flowchart depicting a method for network traffic optimization indicated generally at 400. Method 400 can be implemented on system 100. Persons skilled in the art may choose to implement method 400 on system 100 or variants thereon, or with certain blocks omitted, performed in parallel or in a different order than shown. Method 400 can thus also be varied. However, for purposes of explanation, method 400 will be described in relation to its performance on system 100 with a specific focus on treating method 400 as, for example, application 224-1 maintained within optimization engine 120 and its interactions with the other nodes in system 100.

Block 404 comprises receiving a platform account profile. According to a specific example in system 100, assume that optimization engine 120 receives identifier 128-1 for user 124-1 operating a client device 116-1 accessing a given publisher platform 104-1. The identifier 128-1 is associated with an account profile of the user 124-1. The account profile can be maintained within a dataset 228-1, or elsewhere in system 100. The account profile includes demographic information of the user 124-1 including at least one point-of-interest, for example, a travel destination that the user 124-1 may be interested in. The travel destination can be known directly, such as based on a prior searching activity of the user 124-1 for that destination, or can be known indirectly, such as a popular destination that is of interest to other users 124 of a similar demographic profile to user 124-1, or it can be known indirectly through inference, such as the number of seconds that the user 124-1 pauses on his or her social media feed while content about a destination is displayed. According to the specific example, assume that, according to the account profile, user 124-1 is from Budapest and has point-of-interest or other expressed travel destination interest of London England.

Block 408 comprises receiving a data feed for the profile. The data feed can be based on one or more pieces of primary content associated with the profile. Continuing with the example, assume optimization engine 120 receives content that is being queued for delivery to client device 116-1 by publisher engine 104-1. Optimization engine 120 is configured to examine the content for any content that may be relevant to the point-of-interest from block 404. According to the specific example, assume that, according to the account profile of user 124-1, the data feed includes content that includes a picture, video, text or other content representing London England. Thus at block 408 the fact of the data feed including content representing the point-of-interest from block 404 is determined or otherwise noted.

Block 412 comprises receiving an assignable travel itinerary. The assignable travel itinerary can be a partial or complete travel itinerary that fulfills part or all of the entire sales funnel experience. Continuing with the example, assume optimization engine 120, based on the point-of-interest from block 408, receives secondary content in the form of a complete (or partial) travel itinerary that can be assigned to identifier 128-1. Such a travel itinerary can be built by target platform 112-1, which according to our specific example is a travel actor booking engine in the form of an airline or the like, which if an airline can be powered by a passenger servicing system (PSS) and/or offer management system (OMS), that may participate in an aggregator or a global distribution system (GDS) to assign a draft travel itinerary in the name of user 124-1 including assigning a passenger identifier (e.g. a passenger name record (PNR) and/or a booking reference and/or a record locator, all of which can be implemented as a newly generated sub-object identifier 132), a carrier, travel dates and times, seating class or ticket pricing. The travel itinerary can also include payment authorization on a credit-card (or other electronic credit assessment) or digital wallet (including but not limited to crypto currencies and real-time electronic transfer mechanisms) associated with the user 124-1 Each itinerary may generate additional itineraries of other identifiers 128-2 . . . 128-p of other users 124-2 . . . 124-p, who may be known to typically accompany user 124-1 based on known demographic information for those other users 124. The travel itinerary can be stored anywhere within system 100 for later access, such as on the relevant target platform 112 and/or on the relevant publisher platform 104 and/or the relevant client device 116.

It should be reemphasized that the travel itinerary indicated above is a non-limiting example, and that the travel itinerary can additionally, or alternatively, include other types of itineraries for different travel-actors including accommodations, ground transportation, restaurant bookings and/or event bookings. Other example of travel itineraries will now occur to the person skilled in the art.

Block 416 comprises controlling an electronic device to embed the travel itinerary from block 412 into the data feed from block 408. The term “embed” is not to be construed in a limiting fashion and can include any generation of the travel itinerary alongside primary content on the device. The means by which block 416 is implemented is not particularly limited, and can be effected by optimization engine 120, target platform 112 or content platform 104, sending the travel itinerary combined with the primary content from the data feed to device 116 and generating that combination on the display of device 116. Also note that the combined view on device 116 is interactive and input can be received on device 116 permitting the user 124 to complete a transaction or purchase of the itinerary with “one click”.

According to the specific example, at block 416, the primary content of the data feed (including a picture of London England from 408) can be combined with secondary content (including the travel itinerary of a flight from Budapest to London from block 412) as part of generating the data feed on device 416.

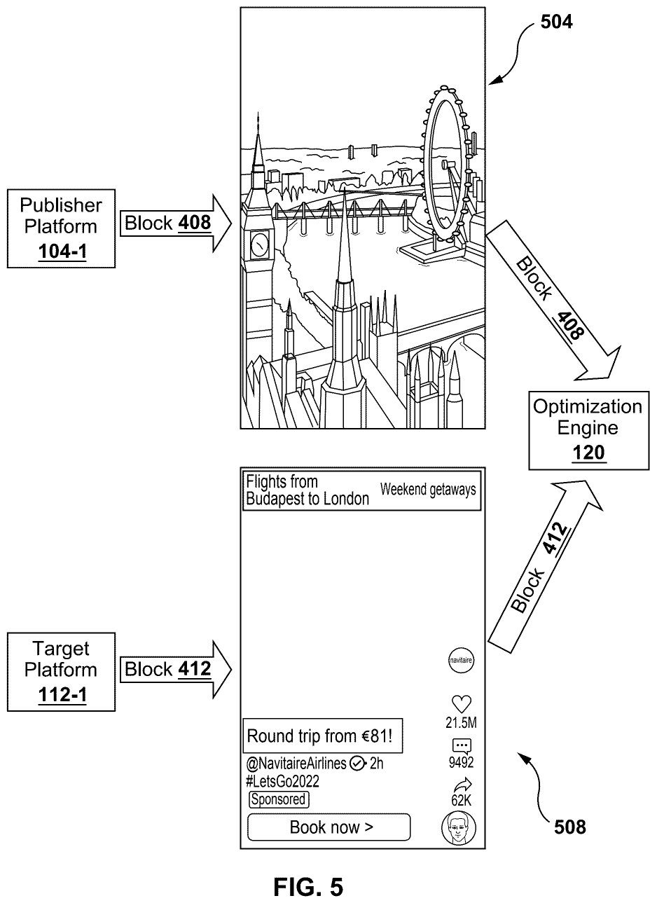

Example performance of block 408 and block 412 is shown in FIG. 5. In FIG. 5, primary content 504 including a picture of London England is received from publisher platform 104-1 at optimization engine 120. Secondary content 508 representing a complete assignable travel itinerary from Budapest to London, including travel dates and times, carrier, etc. and a single click “Book Now” button is generated by target platform 112-1 based on a known origin (Budapest) and interests (London) of user 124-1. Secondary content 508 is also received at optimization engine 120 and forwarded back to publisher platform 104-1.

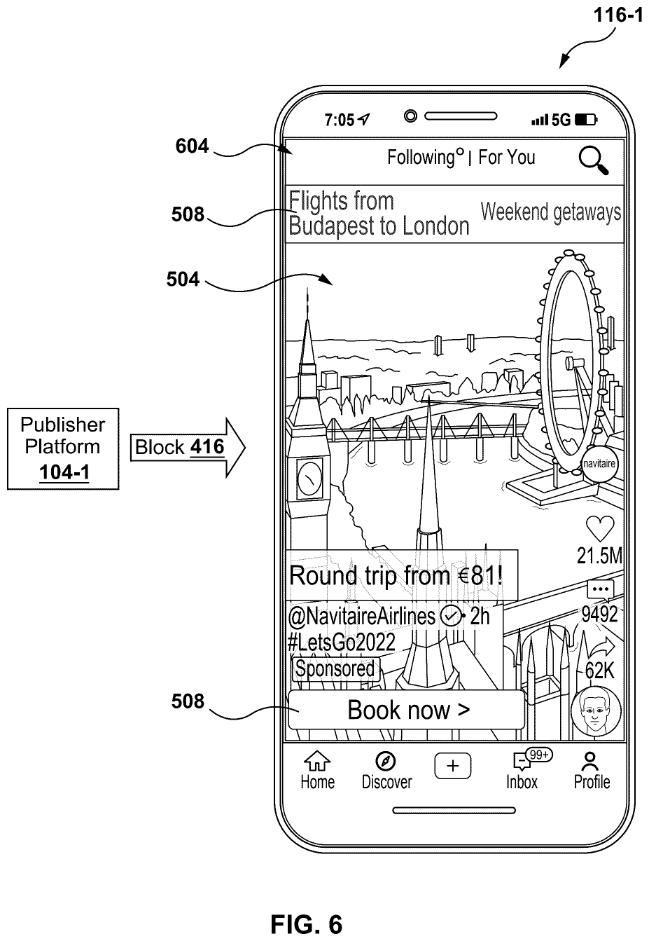

FIG. 6 shows example performance of block 416 whereby platform 104-1 sends combined content 604 (which comprises primary content 504 and second content 508) to device 116-1. While combined content 604 shows secondary content 508 overlaid onto primary content 504, any form of embedding or associating the primary content 504 and the secondary content 508 in association on the display of device 116-1 is contemplated.

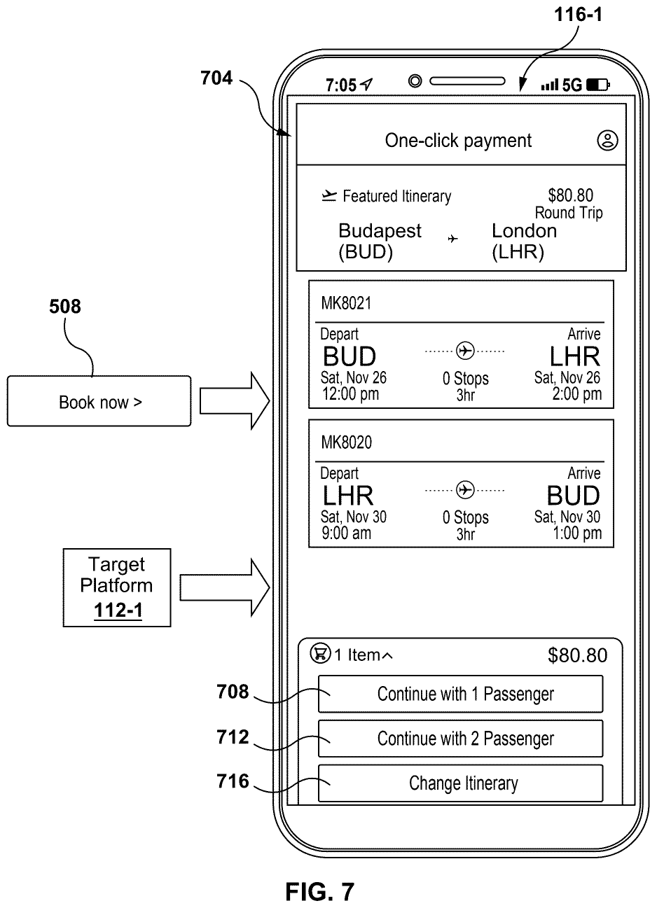

Thus the secondary content according to block 416 can be selected with a first button 608 (to “book now” or “buy now”), or driven directly to a “checkout” page, such that the itinerary, service or product for user 124 can be pre-selected and partially or completely purchased (or put on a temporary hold, potentially for a fee) simply while viewing the primary content they would otherwise already be viewing. In this sense traditional primary content (e.g. social network data feeds) can be merged with and/or overlayed with secondary content (e.g. a partial or complete purchasing fulfillment). This example is shown in FIG. 7 where the button 508 causes device 116-1 to divert from platform 104-1 a landing page (hosted by optimization engine 120 or target platform 112-1, as desired) and generate a checkout page 704 which shows the complete travel itinerary and generates:
a. a second button 708 which can be used to pay for and fulfill the assignment of the travel itinerary to user 124-1, or to alternatively store and/or tokenize and/or reserve and/or encrypt the purchase transaction while leaving the travel itinerary unassigned to the user;
b. a third button 712 which can be used to pay for and fulfill the assignment of the travel itinerary to user 124-1 and to add additional passengers or user 124; and
c. a fourth button 716 to change the itinerary or otherwise move elsewhere in the sales funnel.

The step from FIG. 7 can be obviated when the button 508 is configured as a “one click” purchase equivalent to selecting button 708. By the same token, different buttons other than, or in addition to, second button 708, third button 712 and fourth button 716 can be provided to the screen in FIG. 7.

A technical advantage according to the present specification will now be apparent, since according to the prior art, a diversion to the target platform 112 would include having user 124 interact with client device 116 at the beginning of the sales funnel and the user 124 would have to browse, select and checkout from target platform 112, thereby interfering with their experience on publisher platform 104. The present specification optimizes network, processing and memory resources in system 100 as compared to the prior art, as fewer traffic diversions are enabled and/or less processing on target platform 112 and client device 116 are required to fulfill the sales funnel experience.

A person skilled in the art will now appreciate that the foregoing discussion is generalized and simplified and that many implementation details can be included in an actualization of system 100 as desired. When implemented with TikTok as a platform 104-1, in general terms a TikTok user 116-1 will see secondary content 508 in the form of an advertisement that is associated with an airline's (i.e. a target platform 112) TikTok profile. Within the ad, the TikTok user clicks on the “Book Now” or other “Call To Action” button and can be redirected to device's 116 default browser (or to TikTok's in-app browser) and a landing page experience is rendered from target platform 112 or from optimization engine 120 acting on behalf of the airline.

The landing page experience on device 116 can be customized at the airline's direction. The airline can provide guidance on its requirements per Data Privacy regulations for (1) reporting to TikTok via TikTok Events Application Programming Interface (API) that the landing was successful and (2) non-personally identifiable information (non-PII) (such as analytics of bookings and itineraries). The landing page experience presents an itinerary from the airline as per FIG. 7. The landing page experience enables the user 124 to sign-in to their profile (associated with their identifier 128 or sub-object identifier 132) with the airline or proceed as a guest. The user 124 can buy the itinerary from the airline.

Note that the primary content 504, can be video such as is common on TikTok. The primary content 504 can also be an organic video that was posted under TikTok profile of the target platform 112, such that target platforms 112 become participants in the generation of primary content on platform 104.

Upon selection of first button 708 or second button 712, a booking ID can be displayed on device 116-1 and email confirmation sent to user 124-1 or by other messaging means. End user can optionally share link to the airline's itinerary via messaging.

Reporting applications 154 can be configured to generate analytics (typically, non-PII) for target platforms 112 and/or optimization engine 120 including:
Transactions made according to FIG. 7
Analytics for number of bookings created
Analytics for itineraries used in bookings created.

In view of the above it will now be apparent that variants, combinations, and subsets of the foregoing embodiments are contemplated. For example, optimization engine 120 may be obviated or its function distributed throughout a variant on system 100, such that method 400 can occur inside a publisher platform 104 during a session with a client device 116, with data from block 408 being locally generated inside the platform 104 with appropriate communications with a target platform 112 in order to generate and receive the travel itinerary at block 412. Optimization engine 120 or a variant thereon can also be configured with an application programming interface (API) for ready access to method 400 by publisher platforms 104 and/or target platforms 112.

According to another example variant, in a broader sense, method 400 can be applied to generating secondary content for any purchasing event and embedding that secondary content inside primary content that may be associated with the purchasing event. Thus the specific example in method 400 contemplates generating a complete travel itinerary as second content and embedding, overlaying or associating that travel itinerary as a purchasable event inside primary content that is due for generation on a client device 116. However, the secondary content could be for the purchase of clothing that has the size and color pre-selected along with the payment and shipping information, which is associated with primary content of the same article of clothing.

A person skilled in the art will now appreciate that the teachings herein can improve the technological efficiency and computational and communication resource utilization across system 100 by curating the dissemination of advertising to those publisher platforms 104 that have the greater number of curated and simplified diversions to target platforms 112 or thereby making more efficient use of network and processing resources in system 100. A person of skill in the art will appreciate that prior art generation of secondary content in the form of advertising of destination activities on random client devices 124 without curation can lead to a significant wastage of computing and network resources in system 100. In other words, failure to generate relevant secondary content on platforms 104 that do not lead to diversions to target platforms 112 may lead to wasted generation of secondary content on client devices 116, with attendant waste of network bandwidth on network 108 and processing resources on client devices 116. Furthermore, a failure to generate traffic on target platforms 112 can lead to underutilized processing resources on target platforms 112. Thus, overall load balancing in system 100 is better achieved when traffic is diverted, on a reasonably consistent basis, from publisher platforms 104 to target platforms 112.

It should be recognized that features and aspects of the various examples provided above can be combined into further examples that also fall within the scope of the present disclosure. In addition, the figures are not to scale and may have size and shape exaggerated for illustrative purposes.

1. A server for controlling content for generation on a client device; the server comprising a processor and a memory for storing a plurality of programming instructions for execution on the processor and that when executed configure the processor to:
receive a platform account profile associated with a content platform; the account profile including an origin;
receive a data feed for the account profile from the content platform; the data feed including a destination;
receive a held travel itinerary from a travel-actor data source engine configured to determine the purchasable travel itinerary based on at least one of the origin or the destination; and,
control a client device associated with account profile embedding the purchasable travel itinerary into the data feed.

2. The server of claim 1 wherein the travel itinerary is a transportation routing from the origin to the destination, including a departure date and time, an arrival date and time and a transportation mode.

3. The server of claim 1 wherein the travel itinerary is a lodging at the destination.

4. The server of claim 1 wherein the data feed includes a plurality of segmented primary content items directed to the account profile.

5. The server of claim 1 wherein the destination is derived from an image of the destination, and the travel itinerary is embedded into the image.

6. The server of claim 1 wherein the travel itinerary includes a link that when selected on the client device sends a signal to the travel-actor data source engine that assigns the account profile to the travel itinerary and changes the purchasable travel itinerary to a purchased travel itinerary.

7. The server of claim 6 wherein the account profile is associated with an electronic wallet and wherein the signal causes a change to the electronic wallet commensurate with a value of the travel itinerary.

8. The server of claim 7 wherein the processor is further configured to assign a copy of the purchased travel itinerary to the account profile.

9. The server of claim 1 wherein the account profile is associated with a travel profile and the travel-actor data source engine is configured to determine the travel itinerary additionally based on the travel profile.

10. The server of claim 1 wherein the engine is further configured to determine the itinerary based on one or more of a date range; a price; a promotional code; a lowest price; a shortest travel time; popular days of week and times of day for travel; prevalent lengths-of-stay for travel from the origin to the destination; and, a preferred carrier.
